(19) United States
(12) Patent Application Publication
(10) Pub. No.: US 2024/0325237 A1
(43) Pub. Date: Oct. 3, 2024

(54) SUCKING MASSAGE DEVICE AND SUCKING MASSAGER

(71) Applicants: Chunsheng Peng, Dongguan (CN); Linqing MA, Dongguan (CN); Dongguan Leutoo Silicon Electronics Co., Ltd, Dongguan (CN)

(72) Inventors: Chunsheng Peng, Dongguan (CN); Linqing MA, Dongguan (CN)

(73) Assignees: Chunsheng Peng, Dongguan (CN); Linqing MA, Dongguan (CN); Dongguan Leutoo Silicon Electronics Co., Ltd, Dongguan (CN)

(21) Appl. No.: 18/739,370

(22) Filed: Jun. 11, 2024

(30) Foreign Application Priority Data
Apr. 18, 2024 (CN) 202410472617.7

(51) Int. Cl. A61H 7/00; A61H 23/02

(52) U.S. Cl. CPC A61H 7/008; A61H 23/0254; A61H 2201/0153; A61H 2201/1215

(57) ABSTRACT

A sucking massage device is included in a sucking massager. The sucking massage device includes sucking massage device includes a sucking unit having a massage opening and a variable volume cavity; a trajectory unit having a trajectory main body and a limiting trajectory assembly; a sliding fit unit having a sliding fit main body and a sliding fit assembly; and a driving unit; the trajectory line P₀ is a 3D trajectory line closed at both ends, the trajectory line P₀ is located in a curved column surface S₀, the trajectory main body is connected to the driving unit, and the sliding fit main body is connected to the variable volume cavity; or the trajectory main body is connected to the variable volume cavity, and the sliding fit main body is connected to the driving unit.

### CROSS REFERENCE TO RELATED APPLICATIONS

This application is based upon and claims foreign priority to Chinese Patent Application No. CN202410472617.7, filed on Apr. 18, 2024, the entire contents of which are incorporated herein by reference.

### TECHNICAL FIELD

The present disclosure relates to the technical field of massagers, and particularly relates to a sucking massage device and a sucking massager.

### BACKGROUND

A sucking massager is a device designed for sexual health and pleasure enhancement, providing stimulation effects by simulating actions of oral suction. This type of massager usually includes a suction nozzle capable of fitting in with sensitive areas of a human body, and simulating sucking sensations by creating negative/positive pressure to produce massage effects. The negative/positive pressure is usually generated by an electric pump or mechanical means to form a sealing environment between the suction nozzle and skin, thereby simulating real sucking actions through periodic negative and positive pressure.

In the prior art, for example, a flexible chamber is driven through a drive unit to perform telescopic movement to create a pressure field. The drive unit is composed of a motor and an eccentric wheel, the eccentric wheel is driven to rotate through the eccentric wheel and cause the flexible chamber to periodically generate positive and negative pressure, thereby producing sucking massage effects.

However, when the driving is promoted by the eccentric wheel, the eccentric wheel cannot be very large due to limitation of an installation space. Moreover, once a size of the eccentric wheel is selected, the driving force can be provided (that is, a length that drives a bottom of the flexible chamber to perform telescopic movement in a preset direction per unit time) is only related to a rotational speed of the motor. It is impossible for the motor to have the eccentric wheel rotated at different rotational speed in one rotational cycle. Therefore, when the rotational speed of the motor speed is fixed, the negative pressure generated by driving through the eccentric wheel usually provides constant suction force, making it difficult to generate bursting suction force desired by a user.

A major limitation of the method of eccentric wheel driving for generating positive and negative pressures in a sucking massager is that it cannot change pressure rapidly, making it difficult to achieve bursting pressure changes, this is because a rotation path of the eccentric wheel is predetermined and continuous, causing the driven member to move linearly or cyclically with shape and speed of the eccentric wheel, resulting in a lack of rapid pressure fluctuations.

In the sucking massager driven by the eccentric wheel, the generation of positive and negative pressures depends on movement of a mechanical arm caused by the rotation of the eccentric wheel, inherently limiting rapid release or generation of pressure. A physical shape of a profile of the eccentric wheel predefines a movement trajectory of the driven member, thereby strictly limiting speed and magnitude of pressure changes. Even though the rotational speed of the eccentric wheel increases, rate and intensity of pressure changes are subjected to a certain range, neither rapid nor sudden switch between high pressure and low pressure can be realized, which is a significant limitation for massage scenarios requiring strong stimulation.

Moreover, due to inherent limitations in the design of a driving system of the eccentric wheel, traditional eccentric wheel system are hard to meet diverse and personalized massage patterns desired by the user. The user may seek the simulation effects capable of changing pressure quickly to simulate changeable human sensations, while the eccentric wheel system cannot effectively provide the flexibility and responsiveness due to its inherent method of power transmission.

Therefore, the method of eccentric wheel driving offers advantages of simple mechanical structure and lower cost when designing the sucking massager, but it has obvious shortcomings in providing strong and bursting massage experience.

### SUMMARY

In order to solve the above technical problems, the present disclosure provides a sucking massage device and a sucking massager.

In order to achieve the above objectives, the present disclosure adopts a technical solution as follows:

a sucking massage device having a supporting unit, including:

a sucking unit having a massage opening and a variable volume cavity;

a trajectory unit having a trajectory main body and a limiting trajectory assembly;

a sliding fit unit having a sliding fit main body and a sliding fit assembly; and

a driving unit;

where the trajectory line P₀ is a 3D trajectory line closed at both ends, the trajectory line P₀ is located in a curved column surface S₀, and a number of intersections Mn where a straight line Lₙ intersects with the trajectory line P₀ is 1; and the straight line Lₙ is a straight line arbitrarily passing through a surface of the curved column surface S₀ and parallel to the central axis L₀ of the curved column surface S₀;

where the limiting trajectory assembly is connected with the sliding fit assembly to form a first constraint, and the first constraint is used for limiting the sliding fit assembly and the limiting trajectory assembly to maintain a following state on a trajectory line P₀;

the supporting unit is connected with the trajectory unit and the slide fitting unit to form a second constraint, the second constraint is used for enabling the slide fitting unit to have a degree of freedom to make a circular movement relative to the trajectory unit, and an axis of the circular movement is a central axis L₀; and

the trajectory main body is connected to the driving unit, and the sliding fit main body is connected to the variable volume cavity; or the trajectory main body is connected to the variable volume cavity, and the sliding fit main body is connected to the driving unit; and

the positive pressure and negative pressure are formed in the variable volume cavity under the control of linear movement of the sliding fit main body or the trajectory main body. Preferably, the curved column surface S₀ is a cylindrical curved surface.

Preferably, the limiting trajectory assembly is a groove connected to or formed on the trajectory main body, the sliding fit assembly is a positioning pin connected to or formed on the sliding fit main body, and the positioning pin is matched and defined in the groove; or

the limiting trajectory assembly is a convex rib connected to or formed on the trajectory main body, the sliding fit assembly is a C-shaped groove snap connected to or formed on the sliding assembly main body, and the C-shaped groove snap is snapped into and limited on the convex rib.

Preferably, the trajectory main body is a barrel-shaped structure, and the limiting trajectory assembly is connected to or formed on an inner wall of the barrel-shaped structure; or

the trajectory main body is a column-shaped structure, and the limiting trajectory assembly is connected to or formed on an external wall of the column-shaped structure.

Preferably, the trajectory line P₀ includes:

an adsorption speed drop section having a starting end J₀ and a terminal end J₁;

an adsorption maintenance section having a starting end W₀ and a terminal end W₁;

a pulse pumping section having a starting end C₀ and a terminal end C₁;

where the starting end J₀ is smoothly connected to the terminal end C₁, the terminal end J₁ is smoothly connected to the starting end W₀, and the terminal end W₁ is smoothly connected to the starting end C₀; and

J_{f}>W_{f}, C_{f}>W_{f}, J_{f}, W_{f} and C_{f} are slopes of the sucking speed drop section, the sucking maintenance section, and the pulse pumping section, respectively, and the slope is a ratio of a projection length of a unit trajectory section P₁ of the trajectory line P₀ on the central axis L₀ to a central angle α of the unit trajectory section of the trajectory line on circumference of the curved column surface S₀.

Preferably, J_{f}>m*W_{f}; and

where 3≥m≥1.5.

Preferably, αⱼ≤70°, 100°≤α_{w}≤220°, α_{c}≤70°;

where, αⱼ, α_{w} and α_{c} are central angles of projection arcs of the J_{f}, W_{f} and C_{f} trajectory sections on the circumference of the curved column surface S₀, respectively.

Preferably, it has:

a first elastic unit, and/or a second elastic unit;

where the first elastic unit is disposed on a wall surface of the limiting trajectory assembly away from the variable volume cavity; and elastic energy is stored when the starting end W₀ of the adsorption maintaining section of the trajectory line P₀ rotates in a direction of the terminal end W₁, and the stored elastic energy is released at the starting end C₀ of the pulse pumping section; and

where the second elastic unit is disposed on a wall surface of the limiting trajectory assembly near the variable volume cavity; and elastic energy is stored at the terminal end C₁ of the pulse pumping section of the trajectory line P₀, and the stored elastic energy is released at the starting end J₀ of the adsorption speed drop section.

Preferably, the sucking unit has:

a first deformation surface;

where the first deformation surface is a wall surface of the variable volume cavity connected to the sliding fit main body; or

where the first deformation surface is a wall surface of the variable volume cavity connected to the trajectory main body; and

the first deformation surface is elastically deformable.

Preferably, the sucking unit has:

a second deformation surface;

where the second deformation surface is a side wall surface of the variable volume cavity; and

the second deformation surface is elastic.

in one specific embodiment, at least in a first direction, a diameter of the variable volume cavity increases gradually; and

where the first direction is a direction along the central axis L₀ and directed in a direction of the trajectory unit by the sucking unit.

Preferably, it includes:

a connecting unit;

the connecting unit is disposed between the sliding fit main body and the variable volume cavity; or

the connecting unit is disposed between the trajectory main body and the variable volume cavity.

Preferably, the connecting unit includes:

a first coupling portion and a second coupling portion;

where the first coupling portion is connected to the sliding fit main body or the trajectory main body;

where the second coupling portion is connected to the variable volume cavity; and

the first coupling portion and the second coupling portion are in clearance fit.

Preferably, the sucking massage device has a handheld end D₁ and a working end D₂;

where the driving unit is assembled to the handheld end D₁; and

the variable volume cavity is assembled to the working end D₂.

The present disclosure further provides a sucking massager, including:

the sucking massage device according to any of the above technical solutions.

The present disclosure provides a sucking massage structure and a sucking massager, which has the following beneficial effects:

The sliding fit unit coordinates with the trajectory unit, such that the driving force can be transmitted directly through a shorter path, energy loss is accordingly reduced and response speed is improved. The design of the 3D closed-loop trajectory not only ensures smooth sliding but also effectively prevents structure lagging, such that the transmission efficiency of driving force is further optimized. Moreover, the movement mechanism of the device allows for rapid and intense changes in positive and negative pressure, thereby producing stronger and more effective suction massage stimulation. The present disclosure reduces energy attenuation during the force transmission process, ensuring that the variable volume cavity can quickly and frequently change internal pressure, significantly enhancing the stimulation effects on the massaged part. As a result, the sucking massage device in the present disclosure has significant technical advantages in providing an efficient massage experience.

### BRIEF DESCRIPTION OF THE DRAWINGS

FIG. 1 is a first perspective view of a sucking massage device according to the present disclosure.

FIG. 2 is a second perspective view of a sucking massage device according to the present disclosure (a sliding fit main body is hidden).

FIG. 3 is a first front view of a sucking massage device according to the present disclosure.

FIG. 4 is a second front view of a sucking massage device according to the present disclosure.

FIG. 5 is a first sectional view of a sucking massage device according to the present disclosure (a limiting trajectory assembly is a groove, and a sliding fit assembly is a positioning pin).

FIG. 6 is a partial enlarged schematic diagram of a structure at position A in FIG. 5.

FIG. 7 is a second sectional view of a sucking massage device according to the present disclosure (a limiting trajectory assembly is a convex rib, and a sliding fit assembly is a C-shaped groove snap).

FIG. 8 is a first perspective view of a trajectory main body in a sucking massage device according to the present disclosure.

FIG. 9 is a second perspective view of a trajectory main body in a sucking massage device according to the present disclosure.

FIG. 10 is a third perspective view of a trajectory main body in a sucking massage device according to the present disclosure.

FIG. 11 is a fourth perspective view of a trajectory main body in a sucking massage device according to the present disclosure.

FIG. 12 is a schematic diagram of central angles αⱼ, α_{w} and α_{c} in a sucking massage device according to the present disclosure.

FIG. 13 is a first sectional view of a sucking massage device according to the present disclosure (a variable volume cavity generates negative pressure).

FIG. 14 is a partial enlarged schematic diagram of a structure at position B in FIG. 13.

FIG. 15 is a second sectional view of a sucking massage device according to the present disclosure (a variable volume cavity generates positive pressure).

FIG. 16 is a partial enlarged schematic diagram of a structure at position B in FIG. 15.

FIG. 17 is a structural schematic diagram of a variable volume cavity showing a regular trapezoid.

FIG. 18 is a structural schematic diagram of a variable volume cavity showing an inverted trapezoid.

FIG. 19 is a structural schematic diagram of a massage opening showing a circular shape.

FIG. 20 is a structural schematic diagram of a massage opening showing a quasi-circular shape.

FIG. 21 is a structural schematic diagram of a massage opening showing two circular shapes.

FIG. 22 is an exploded view of a sucking massage device according to the present disclosure.

### REFERENCE NUMERALS IN THE ACCOMPANYING DRAWINGS

1. supporting unit; 101. slide groove; 102. slide block; 2. sucking unit; 201. massage opening; 202. variable volume cavity; 2021. first deformation surface; 2022. second deformation surface; 3. trajectory unit; 301. trajectory main body; 302. limiting trajectory assembly; 3021. groove; 3022. convex rib; 4. sliding fit unit; 401. sliding fit main body; 402. sliding fit assembly; 4021. positioning pin; 4022. C-shaped groove snap; 5. driving unit; 501. motor; 6. housing; 701. adsorption speed drop section; 702. adsorption maintenance section; 703. pulse pumping section; 801. first elastic unit; 802. second elastic unit; 9. connecting unit; 901. first coupling portion; 902. second coupling portion; 10. massager; 11. electric control module; and 12. part to be massaged.

### DETAILED DESCRIPTIONS OF THE EMBODIMENTS

The technical solutions of embodiments of the present disclosure will be described below clearly and comprehensively in conjunction with accompanying drawings of the embodiments of the present disclosure. Apparently, the embodiments described are merely some embodiments rather than all embodiments of the present disclosure. All the other embodiments obtained by those of ordinary skill in the art based on the embodiments in the present disclosure without creative efforts shall fall within the scope of protection of the present disclosure.

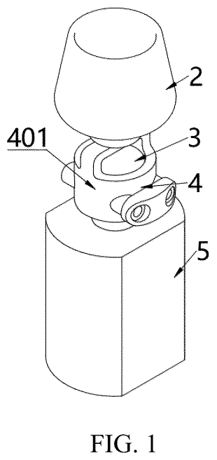

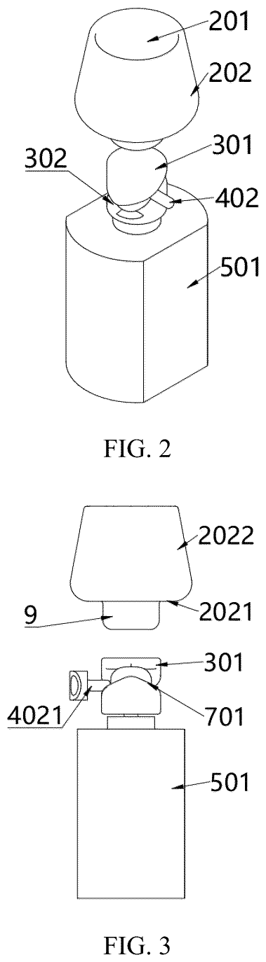

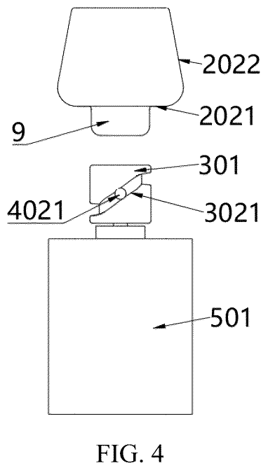

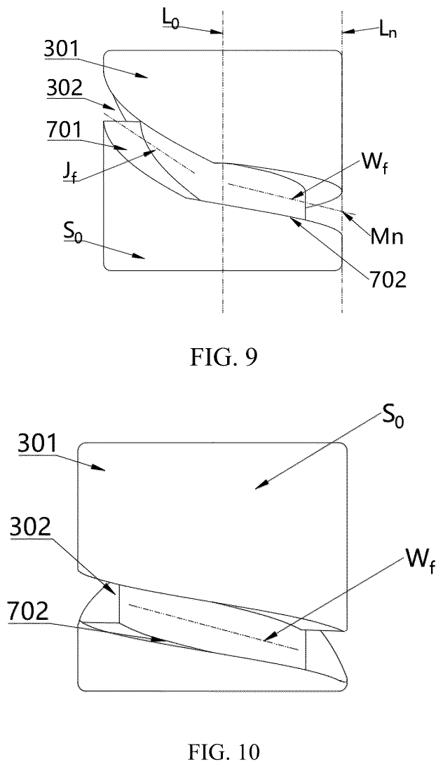

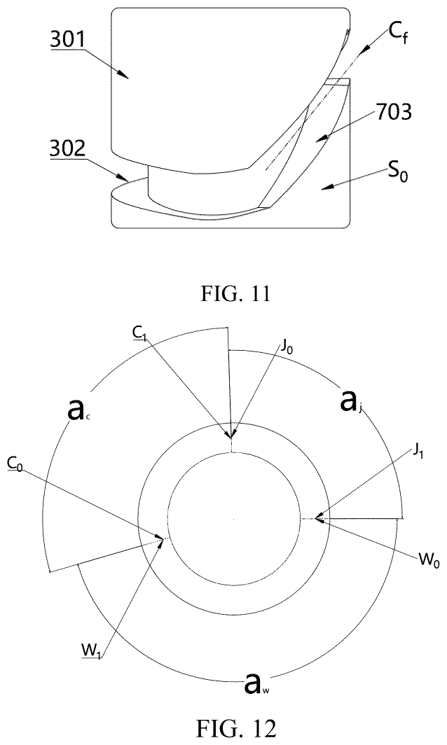

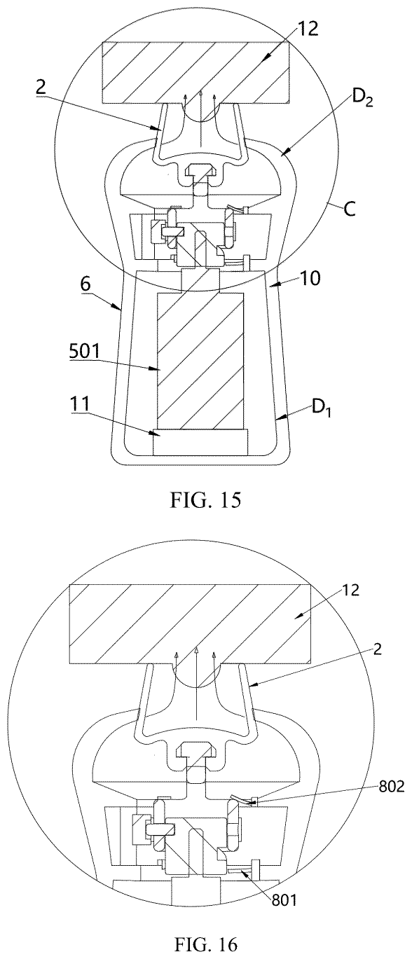

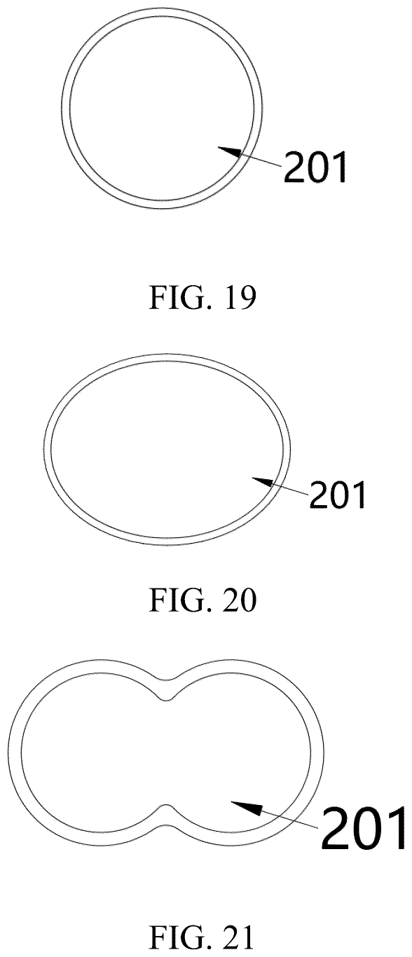

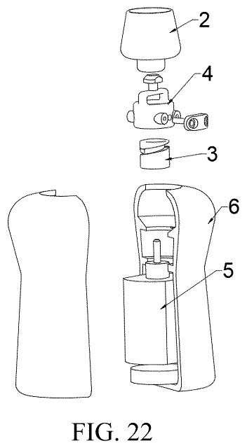

With reference to FIGS. 1-22, specific embodiments provided by the present disclosure are as follows:

as shown in FIGS. 1-4, a first embodiment of the present disclosure provides a sucking massage device, which has a supporting unit 1, including:

a sucking unit 2 having a massage opening 201 and a variable volume cavity 202, where the massage opening 201 is configured to cling to a skin surface of a massaged part during massage;

a trajectory unit 3 having a trajectory main body 301 and a limiting trajectory assembly 302;

a sliding fit unit 4 having a sliding fit main body 401 and a sliding fit assembly 402;

and a driving unit 5;

where the limiting trajectory assembly 302 is connected with the sliding fit assembly 402 to form a first constraint, and the first constraint is used for limiting the sliding fit assembly 402 and the limiting trajectory assembly 302 to maintain a following state on a trajectory line P₀;

the supporting unit 1 is connected with the trajectory unit 3 and the slide fitting unit 4 to form a second constraint, the second constraint is used for enabling the slide fitting unit 4 to have a degree of freedom to make a circular movement relative to the trajectory unit 3, and an axis of the circular movement is a central axis L₀; and

in this embodiment, the form of positive and negative pressure generated by driving an eccentric wheel in the prior art is changed with the purpose of providing relatively fast fluctuating positive and negative pressure generating capabilities to produce relatively strong massage stimulation effects.

As shown in FIG. 8, specifically, the limiting trajectory assembly 302 has the trajectory line P₀, and the trajectory line P₀ is a 3D trajectory line closed at both ends. It should be noted that the trajectory line P₀ is located in a curved column surface S₀, and a number of intersections Mn where a straight line Lₙ intersects with the trajectory line P₀ is 1; and the straight line Lₙ is a straight line arbitrarily passing through a surface of the curved column surface S₀ and parallel to the central axis L₀ of the curved column surface S₀. The trajectory line P₀ is embodied as a groove formed on a circumferential wall surface of the trajectory main body 301, and the trajectory main body 301 is embodied as a column structure, and the circumferential wall surface thereof is the surface of the curved column surface S₀. That is to say, the trajectory line P₀ is integrally formed with the trajectory main body 301, and the trajectory line P₀ forms a continuous and closed-loop groove on the circumferential wall surface of the trajectory main body 301, that is, the surface of the curved column surface S₀, such that when the sliding fit main body 401 is slidably connected in the groove, and the driving unit 5 drives the sliding fit main body 401 or the trajectory main body 301 to rotate in a form of rotational driving, the sliding fit main body 401 and the trajectory main body 301 can slide relative to each other; further, taking one of the main bodies as a reference object, the other main body slides relatively along the trajectory line P₀, such that the other main body (that is, the sliding fit main body 401 or the trajectory main body 301) performs periodic movement towards the variable volume cavity 202 and away from the variable volume cavity 202 in a direction of the central axis L₀, finally resulting in changes in positive pressure and negative pressure inside the variable volume cavity 202. When the massage opening 201 comes into contact with a part to be massaged 12, sucking massage effects are produced for the part to be massaged 12 through changes in the pressure inside the variable volume cavity 202 (that is, generation of the positive pressure and the negative pressure).

The curved column surface S₀ is a cylindrical curved surface, this is because after the trajectory line P₀ is formed along the cylindrical curved surface, a smooth configuration will exhibit, such that structure lagging can be reduced, a loss of driving force (acting force provided by the driving unit 5) can be accordingly reduced, thereby ensuring an effective transmission of the driving force, and finally improving strong sucking massage effects of the variable volume chamber 202.

The part to be massaged 12 can be labia or a clitoris.

The positive pressure and the negative pressure are calibrated relative to atmospheric pressure or normal pressure. Air pressure higher than the atmospheric pressure or higher than a pressure of a surface the part to be massaged 12 (an air pressure of the part to be massaged 12 not in contact with the sucking massage device) is defined as the positive pressure, and otherwise, the negative pressure is defined.

The 3D trajectory should be understood as having a position difference in the direction of the central axis L₀, for example, the 3D trajectory is a closed-loop spiral, and the position difference causes the sliding fit main body 401 or the trajectory main body 301 to perform periodic movement towards the variable volume cavity 202 and away from the variable volume cavity 202, thereby causing the changes in the positive pressure and the negative pressure.

The positive pressure and negative pressure are formed in the variable volume cavity 202 under the control of linear movement of the sliding fit main body 401 or the trajectory main body 301.

As described above, the trajectory main body 301, the sliding fit main body 401, the variable volume cavity 202, and the driving unit 5 have the following two connection forms.

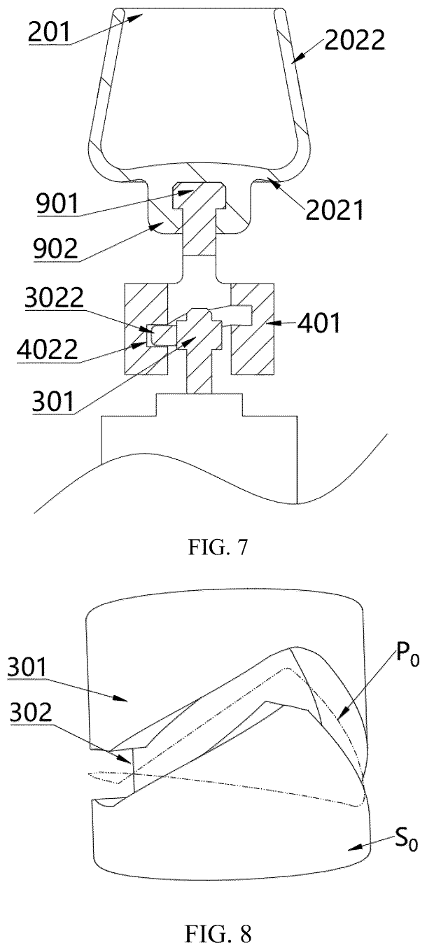

As shown in FIG. 7, firstly, the trajectory main body 301 is connected to the driving unit 5, and the sliding fit main body 401 is connected to the variable volume cavity 202.

Specifically, the driving unit 5 (that is, a driving motor 501) rotates to drive the rotation of the trajectory main body 301, such that the sliding fit main body 401 passively slides along the trajectory line P₀, and finally performs periodic movement towards or away from the variable volume cavity 202, and the movement causes the variable volume cavity 202 to generate the changes in the positive pressure and the negative pressure.

When the sliding fit main body 401 moves towards the variable volume cavity 202, the sliding fit main body 401 squeezes the variable volume cavity 202, the variable volume cavity 202 suffers a deformation, and the volume thereof is reduced, such that the air pressure rises, and the change in the positive pressure is formed. When the sliding fit main body 401 moves away from the variable volume cavity 202, the sliding fit main body 401 stretches the variable volume cavity 202, the variable volume cavity 202 suffers a deformation, and the volume thereof is increased, such that the air pressure decreases, and the change in the negative pressure is formed.

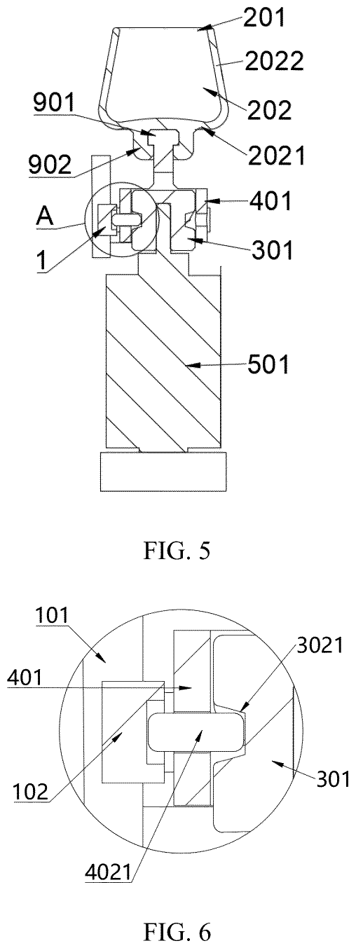

As shown in FIG. 5, secondly, the trajectory main body 301 is connected to the variable volume cavity 202, and the sliding fit main body 401 is connected to the driving unit 5.

Specifically, the driving unit 5 (that is, the driving motor 501) rotates to drive the rotation of the sliding fit main body 401, and due to the existence of the trajectory line P₀, the trajectory main body 301 passively performs periodic movement towards or away from the variable volume cavity 202, and the movement causes the variable volume cavity 202 to generate the changes in the positive pressure and the negative pressure.

When the trajectory main body 301 moves towards the variable volume cavity 202, the trajectory main body 301 squeezes the variable volume cavity 202, the variable volume cavity 202 suffers a deformation, and the volume thereof is reduced, such that the air pressure increases, and the change in the positive pressure is formed. When the trajectory main body 301 moves away from the variable volume cavity 202, the trajectory main body 301 stretches the variable volume cavity 202, the variable volume cavity 202 suffers a deformation, and the volume thereof is increased, such that the air pressure decreases, and the change in the negative pressure is formed.

The above two connection forms can both convert the rotational movement of the driving unit 5 into the linear movement, and are different from the prior art that an eccentric wheel drives the variable volume cavity 202 in the following ways:

first, structural forms of the sliding fit unit 4 and the trajectory unit 3 provided in this embodiment can shorten a transmission path of the driving force (that is, the acting force provided by the driving unit 5) to some extent, such that the sliding fit unit 4 or the trajectory unit 3 can accelerate a response speed of the positive pressure and the negative pressure generated by the variable volume cavity 202.

The specific reason is that in the prior art, the driving force generated by the driving motor 501 causes the eccentric wheel to rotate, that is, the driving force is transmitted towards the eccentric wheel. The eccentric then drives a driven member (such as, a driven connecting rod) to perform linear movement, that is, the driving force is transmitted towards the driven member. Finally, the driven member drives the variable volume cavity 202 to deform, that is, the driving force is transmitted to the variable volume cavity 202.

In this embodiment, the driving force generated by the driving motor 501 is directly applied to the sliding fit main body 401 or the trajectory main body 301, that is, the driving force is transmitted to the sliding fit main body 401 or the trajectory main body 301. Subsequently, the sliding fit main body 401 or the trajectory main body 301 drives the variable volume cavity 202 to deform, that is, the driving force is transmitted to the variable volume cavity 202.

Through comparison, it can be seen that the sliding fit unit 4 and the trajectory unit 3 provided in this embodiment cooperate with each other to transmit the driving force more directly, and the transmission path is shorter, such that consumption or loss of the driving force is reduced, and finally, the massage stimulation effects with obvious fluctuations of the part to be massaged 12 are produced.

Further, in the prior art, since it is applied to a hand-held massager, a size and a space are limited, an eccentric wheel is used for driving, and a diameter of the eccentric wheel determines lengths of a compression stroke and a stretching stroke of the variable volume cavity 202. Due to the limited size and space, the diameter of the eccentric wheel is not allowed to be very large, which results in limited compression and extension of the variable volume chamber 202, and finally resulting in weaker massage stimulation effects. In this embodiment, a slope of the trajectory line P₀ can be customized. For example, when a user desires stronger massage stimulation effects, the slope of the trajectory line P₀ can be increased, and when the user desires gentler massage stimulation effects, the slope of the trajectory line P₀ can be decreased. Further, the stretching stroke and the compression stroke of the variable volume cavity are not controlled by the diameter of the eccentric wheel any more, such that a product with strong massage stimulation effects can be designed in spite of a size limit of the hand-held massager.

Second, the structural forms of the sliding fit unit 4 and the trajectory unit 3 provided in this embodiment can avoid the change of the transmission path of the driving force to some extent, such that the attenuation of the driving force is slowed down to a greater extent, and finally, the variable volume cavity 202 provides significant massage stimulation effects to the part to be massaged 12.

The specific reason is that in the prior art, an axis of the driving motor 501 is perpendicular to an axis of the variable volume cavity 202, that is, the transmission path of the driving force from the driving motor 501 to the eccentric wheel is also perpendicular to the transmission path of the driving force from the eccentric wheel to the driven member. It can be visualized as follows: the driving force needs to be transmitted along two mutually perpendicular straight lines, which causes a transmission loss of the driving force, resulting in attenuation of the driving force transmitted to the variable volume cavity 202, and finally resulting in a significant reduction in the massage stimulation effects of the variable volume cavity 202 on the part to be massaged 12; and meanwhile, since the vertical design of the driving motor and the variable volume cavity must be ensured, it cannot be used in an environment with a limited assembly space.

In this embodiment, an axis of the driving unit 5 and an axis of the sliding fit main body 401 or the trajectory main body 301 are in the same straight line, that is, the driving force generated by the driving motor 501 can be directly transmitted to the sliding fit main body 401 or the trajectory main body 301, and the driving force is finally transmitted to the variable volume cavity 202 in a relatively short time in a form of less loss of the driving force, such that the variable volume cavity 202 provides stronger massage stimulation effects on the part to be massaged 12.

On the basis of the above, consideration needs to be given to the following points:

first, the sliding fit main body 401 and the trajectory main body 301 need to have a large degree of relative movement. For example, if the sliding fit main body 401 and the trajectory main body 301 form synchronous rotation, they will not passively move along the trajectory line P₀ at all, and the deformation of the variable volume cavity 202 cannot be formed.

Second, after the above conditions are satisfied, it is necessary to ensure the connectivity between the sliding fit main body 401 and the trajectory main body 301, such that, on the one hand, the sliding fit main body 401 and the trajectory main body 301 do not disengage from each other while ensuring synchronous rotation between them, and on the other hand, the synchronous rotation between them can be efficiently converted into the linear movement of one main body, thereby ensuring that the deformation response speed of the variable volume cavity 202 becomes faster.

As a result, a first constraint and a second constraint are introduced.

As shown in FIGS. 5-6, the first constraint is formed by the connection of the sliding fit assembly 402 and the limiting trajectory assembly 302. Specifically, the sliding fit assembly 402 is connected to the sliding fit main body 401 and the limiting trajectory assembly 302, respectively, so as to ensure that the sliding fit assembly 402 (and the sliding fit main body 401) and the limiting trajectory assembly 302 (and the trajectory main body 301) keep a following state on the trajectory line P₀, that is, the two are not disengaged from each other to ensure the efficiency of converting the rotation into the linear movement.

The second constraint is formed by the supporting unit 1. Specifically, the supporting unit 1 is in the form of a slide groove 101 and a slide block 102, the slide groove 101 is formed in an inner wall surface of a housing 6, the slide block 102 is attached to an outer wall surface of the slide fitting main body 401, the slide groove 101 and the slide block 102 form a sliding fit, and further, the slide groove 101 is arranged in the direction of the central axis L₀. The second constraint is used for enabling the slide fitting unit 4 to have a degree of freedom to make a circular movement relative to the trajectory unit 3, and an axis of the circular movement is a central axis L₀. That is, the sliding fit unit 4 can rotate relative to the trajectory unit 3, thereby avoiding the problem that the two units cannot convert the rotation into the linear movement due to synchronous rotation.

A second embodiment of the present disclosure provides a sucking massage device, and on the basis of the first embodiment, the trajectory main body 301 is a barrel-shaped structure, and the limiting trajectory assembly 302 is connected to or formed on an inner wall of the barrel-shaped structure; or

The trajectory main body 301 is a column-shaped structure, and the limiting trajectory assembly 302 is connected to or formed on an external wall of the column-shaped structure.

On the basis of the above, two assembly forms of the sliding fit main body 401 and the trajectory main body 301 are provided.

As shown in FIGS. 5-7, the limiting trajectory assembly 302 is a groove 3021 connected to or formed on the trajectory main body 301, the sliding fit assembly 402 is a positioning pin 4021 connected to or formed on the sliding fit main body 401, and the positioning pin 4021 is matched and defined in the groove 3021.

Specifically, one end of the positioning pin 4021 is connected to the sliding fit main body 401, and the other end thereof is slidably connected in the groove 3021. The sliding of the positioning pin 4021 in the groove 3021 causes the sliding fit main body 401 to form linear movement, or the positioning pin 4021 causes the trajectory main body 301 to form linear movement through the groove 3021, thereby driving the changes in positive pressure and negative pressure inside the variable volume cavity 202.

The limiting trajectory assembly 302 is a convex rib 3022 connected to or formed on the trajectory main body 301, the sliding fit assembly 402 is a C-shaped groove snap 4022 connected to or formed on the sliding assembly main body 401, and the C-shaped groove snap 4022 is snapped into and limited on the convex rib 3022.

Specifically, the convex rib 3022 is slidably connected to the C-shaped groove snap 4022. The sliding of the convex rib 3022 in the C-shaped groove snap 4022 causes the sliding fit main body 401 to form linear movement, or the convex rib 3022 causes the trajectory main body 301 to form linear movement through the C-shaped groove snap 4022, thereby driving the changes in positive pressure and negative pressure inside the variable volume cavity 202.

As shown in FIGS. 8-11, a third embodiment of the present disclosure provides a sucking massage device, and on the basis of the previous embodiment, the trajectory line P₀ includes:

an adsorption speed drop section 701 having a starting end J₀ and a terminal end J₁;

an adsorption maintenance section 702 having a starting end W₀ and a terminal end W₁;

a pulse pumping section 703 having a starting end C₀ and a terminal end C₁;

where the starting end J₀ is smoothly connected to the terminal end C₁, the terminal end J₁ is smoothly connected to the starting end W₀, and the terminal end W₁ is smoothly connected to the starting end C₀; and

J_{f}>W_{f}, C_{f}>W_{f}, J_{f}, Wᵣ and C_{f} are slopes of the adsorption speed drop section 701, the adsorption maintenance section 702, and the pulse pumping section 703, respectively, and the slope is a ratio of a projection length of a unit trajectory section P₁ of the trajectory line P₀ on the central axis L₀ to a central angle α of the unit trajectory section of the trajectory line on a circumference of the curved column surface S₀.

It should be understood that the terminal end of one section is at a position same as the starting end of a next section. For example, the terminal end J₁ of the adsorption speed drop section 701 is at a position same as the starting end W₀ of the adsorption maintenance section 702, the terminal end W₁ of the adsorption maintenance section 702 is at a position same as the starting end C₀ of the pulse pumping section 703, and the terminal end C₁ of the pulse pumping section 703 is at a position same as the starting end J₀ of the adsorption speed drop section 701, such that a closed-end trajectory line P₀ is formed.

In this embodiment, it is further found that when the opening of the variable volume cavity is not in close contact with skin of the massaged part during use, that is, an air leakage gap exists, adsorption massage effects produced by the negative pressure will be significantly reduced; and when the air leakage gap becomes large, it may even lead to the inability to produce sucking effects of the negative pressure.

On this basis, this embodiment is intended to solve the above problems, such that when the massage device is used, even though the operation is not standardized, and a larger gap exists between the massage opening 201 and the part to be massaged 12, sucking massage stimulation can be provided to the user.

Therefore, the trajectory line P₀ is divided into the adsorption speed drop section 701, the adsorption maintenance section 702, and the pulse pumping section 703.

Specifically, J_{f} of the adsorption speed drop section 701 is relatively large, such that a change rate of the linear movement of the sliding fit main body 401 or the trajectory main body 301 is significantly increased, and when the sliding fit main body 401 and the trajectory main body 301 are in sliding fit in this section, allowing the sliding fit main body 401 or the trajectory main body 301 to drive the changes in the negative pressure the variable volume cavity 202 in a relatively short time, and finally causing the variable volume cavity 202 to produce obvious absorption massage stimulation effects.

Further, since the negative pressure is generated at a faster speed in a short time, the adsorption maintenance section 702 is introduced, so as to ensure that the part to be massaged 12 is subjected to the sucking massage stimulation effects for a long period. Further, the slope W_{f} of the adsorption maintenance section 702 is relatively minimal for the purposes of prolonging action time of the sliding fit main body 401 or the trajectory main body 301 in this section, and finally time for maintaining a negative pressure state of the variable volume cavity 202 is prolonged, such that time of sucking massage stimulation effects acting on the part to be massaged 12 in prolonged.

Further, the slope Cr of the pulse pumping section 703 is relatively moderate, and when the sliding fit main body 401 and the trajectory main body 301 are in sliding fit in this section, it is embodied that the sliding fit main body 401 or the trajectory main body 301 performs the linear movement towards the variable volume cavity 202, such that the variable volume cavity 202 enters a positive pressure state, and finally, corresponding massage stimulation effects are provided to the part to be massaged 12. Of course, a duration of the positive pressure state and a speed of forming the positive pressure state are relatively moderate, so as to form a significant difference with a duration and a speed of the negative pressure state, and finally ensure that the user feels clearly different massage stimulation effects produced by the positive pressure and the negative pressure.

J_{f}>m*W_{f}; and

3≥m≥1.5.

The reason for setting this formula is that: when J_{f} of the adsorption speed drop section 701 is significantly greater than the slope W_{f} of the adsorption maintenance section 702 by 1.5 times or 2 times or 3 times, and a change rate of the linear movement of the sliding fit main body 401 or the trajectory main body 301 in a negative pressure forming stage is significantly higher than that in a negative pressure maintaining stage, such that the part to be massaged 12 can feel a significant difference in pressure changes. Specifically, the negative pressure forming stage is a stage in which the variable volume cavity 202 sucks air from an outside, the massage stimulation effects felt by the user is relatively strong and obvious in this stage, and the negative pressure maintaining stage is a stage in which the variable volume cavity 202 maintains the current negative pressure for a certain time after the negative pressure forming stage, such that effective acting time of the adsorption massage stimulation effects produced by the negative pressure on the part to be massaged 12 is prolonged, and finally the user feels stronger massage stimulation effects.

As shown in FIGS. 12, a fourth embodiment of the present disclosure provides a sucking massage device, and on the basis of the previous embodiment, αⱼ≤70°, 100°≤α_{w}≤220°, and α_{c}≤70°;

where, αⱼ, α_{w} and α_{c} are central angles of projection arcs of the J_{f}, W_{f} and C_{f} trajectory sections on the circumference of the curved column surface S₀, respectively.

In this embodiment, as described above, the present disclosure expects that the massage stimulation effects produced by the negative pressure of the positive variable volume cavity 202 is significantly stronger than the massage stimulation effects produced by the positive pressure thereof.

On this basis, in addition to the above significant difference in the change rate of the linear movement of the sliding fit main body 401 or the trajectory main body 301, time of a negative pressure production stage can be prolonged, that is, the negative pressure stage is formed at a faster rate and lasts for a longer period of time, thereby ensuring that the user is subjected to more stronger and longer-cycle sucking massage stimulation effects.

Therefore, the central angles αⱼ, α_{w} and α_{c} projected by the trajectory sections J_{f}, W_{f} and C_{f}, that is, the adsorption speed drop section 701, the adsorption maintenance section 702, and the pulse pumping section 703 on the circumference of the curved column surface S₀ represent the strokes of the respective sections, the larger the central angles are, the larger the strokes of the section become, that is, the longer the period in which the positive pressure or the negative pressure of the variable volume cavity 202 subject to the movement of the sliding fit main body 401 or the trajectory main body 301 in the section is longer. As described above, this embodiment expects that a period of the negative pressure state in the variable volume cavity 202 is prolonged, and the change rate of the negative pressure state becomes faster, therefore, the central angle αⱼ of the adsorption speed drop section 701 is set to a value within 100° to 220°, for example, 100°, 150°, 200° or 220°. As long as the central angle αⱼ of the adsorption speed drop section 701 is much larger than those of the other sections to a certain extent. It is found that, during use, since the central angle occupied by the adsorption speed drop section 701 is relatively larger, the movement period of the sliding fit main body 401 or the trajectory main body 301 in this section is longer, and as mentioned above, the sliding fit main body 401 and the trajectory main body 301 have larger change rates in this section, such that strong and significant absorption massage stimulation effects can be produced in the variable volume cavity 202, thereby ensuring that the user feels obvious stimulation sensation.

Of course, since parameters (the duration and the change rate) of the positive pressure state formed by the variable volume cavity 202 are significantly different from parameters of the negative pressure state, the switching between the positive pressure state and the negative pressure state has a strong contrast, and the user can further feel stronger massage stimulation effects by sensing the strong contrast.

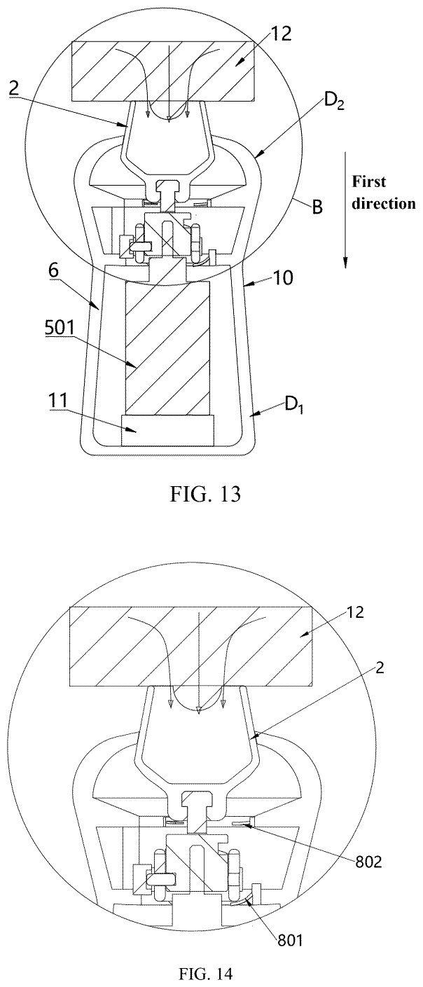

As shown in FIGS. 13-16, a fifth embodiment of the present disclosure provides a sucking massage device, and on the basis of the previous embodiment, the sucking massage device further includes:

a first elastic unit 801, and/or a second elastic unit 802;

where the first elastic unit 801 is disposed on a wall surface of the limiting trajectory assembly 302 away from the variable volume cavity 202; and elastic energy is stored when the starting end W₀ of the adsorption maintaining section 702 of the trajectory line P₀ rotates in a direction of the terminal end W₁, and the stored elastic energy is released at the starting end C₀ of the pulse pumping section 703; and

where the second clastic unit 802 is disposed on a wall surface of the limiting trajectory assembly 302 near the variable volume cavity 202; and elastic energy is stored at the terminal end W₁ of the pulse pumping section 703 of the trajectory line P₀, and the stored elastic energy is released at the starting end J₀ of the adsorption speed drop section 701.

In this embodiment, it is further found that when the sliding fit main body 401 or the trajectory main body 301 slides relatively along the trajectory line P₀, the sliding fit main body 401 or the trajectory main body 301 collides with the trajectory line P₀ (specifically, the limiting trajectory assembly 302 collides with the groove 3021 formed on the trajectory line P₀), especially at the terminal ends of the adsorption speed drop section 701, the absorption maintaining section 702 and the pulse pumping section 703, and the collision significantly consumes the driving force, thereby weakening effects of the driving force on the variable volume cavity 202.

On this basis, the first elastic unit 801, and the second elastic unit 802 are introduced.

In a stage of transition from the adsorption maintaining section 702 to the pulse pumping section 703, this embodiment expects that the first elastic unit 801 is capable of absorbing energy of the adsorption maintaining section 702, that is, energy generated by collision between the sliding fit main body 401 or the trajectory main body 301 and the trajectory line P₀ (specifically, the limiting trajectory assembly 302 collides with the groove 3021 formed on the trajectory line P₀), and particularly, energy at the terminal end W₁ of the adsorption maintaining section 702 is absorbed and stored. The absorbed and stored energy is released at the starting end C₀ of the pulse pumping section 703 to help the sliding fit main body 401 or the trajectory main body 301 have higher kinetic energy at the pulse pumping section 703, such that a greater deformation of the variable volume cavity 202, the thrust of the variable volume cavity to the gas is sufficient, and massage stimulation effects in a burst-type positive pressure state.

Correspondingly, in a stage of transition from the pulse pumping section 703 to the adsorption speed drop section 701, this embodiment expects that the second elastic unit 802 is capable of absorbing energy of the pulse pumping section 703, that is, energy generated by collision between the sliding fit main body 401 or the trajectory main body 301 and the trajectory line P₀ (specifically, the limiting trajectory assembly 302 collides with the groove 3021 formed on the trajectory line P₀), and particularly, energy at the terminal end C₁ of the pulse pumping section 703 is absorbed and stored. The absorbed and stored energy is released at the starting end C₀ of the adsorption speed drop section 701 to help the sliding fit main body 401 or the trajectory main body 301 have higher kinetic energy at the adsorption speed drop section 701, such that a greater deformation of the variable volume cavity 202, the suction of the variable volume cavity to the gas is sufficient, and massage stimulation effects in a burst-type negative pressure state.

In one specific implementation of this embodiment, the first elastic unit 801 and the second elastic unit 802 are elastic sheets. The elastic sheets absorb and release elastic energy storage through deformation.

As shown in FIGS. 1-4, a sixth embodiment of the present disclosure provides a sucking massage device, and on the basis of the previous embodiment, the sucking massage device further has:

a first deformation surface 2021;

where the first deformation surface 2021 is a wall surface of the variable volume cavity 202 connected to the sliding fit main body 401; or

where the first deformation surface 2021 is a wall surface of the variable volume cavity 202 connected to the trajectory main body 301; and

the first deformation surface 2021 is elastically deformable.

In this embodiment, the sliding fit main body 401 or the trajectory main body 301 is connected to the first deformation surface 2021 to cause the first deformation surface 2021 to deform to form a negative pressure state and a positive pressure state. Of course, remaining wall surfaces of the variable volume cavity 202 can be made of hard material, that is, only the first deformation surface 2021 needs to be made of elastic material, and the remaining wall surfaces of the variable volume cavity 202 can also be made of the elastic material same as or different from the first deformation surface 2021.

A seventh embodiment of the present disclosure provides a sucking massage device, and on the basis of the previous embodiment, the sucking massage device further includes: the first deformation surface 2021;

where the first deformation surface 2021 is a bottom of the variable volume cavity 202;

the second deformation surface 2022;

where the second deformation surface 2022 is a side wall surface of the variable volume cavity 202; and

the second deformation surface 2022 is elastic.

In this embodiment, the second deformation surface 2022 is further provided, this is because the variable volume cavity 202 has one deformation surface, weakening its capability to inhale and exhale has, such that massage stimulation effects are significantly reduced. Moreover, in order to ensure that the massage opening 201 can form a relatively close contact with the part to be massaged 12 to reduce the gap between the massage opening and the part to be massaged, so as to ensure the massage stimulation effects, the second deformation surface 2022 is further introduced.

When the massage opening 201 contacts the part to be massaged 12, the second deformation surface 2022 can be compressed, such that the massage opening 201 can be tightly attached to the part to be massaged 12 without causing excessive pressure to the part to be massaged 12, and the capacity of the variable volume cavity 202 for sucking and discharging air can be further increased on the basis of ensuring that the gap between the massage opening 201 and the part to be massaged 12 is reduced.

In one embodiment, the variable volume cavity 202 is made of silicon gel.

In one embodiment, the first deformation surface 2021 of the variable volume cavity 202 is made of silicon gel, and the remaining wall surfaces thereof are made of hard material.

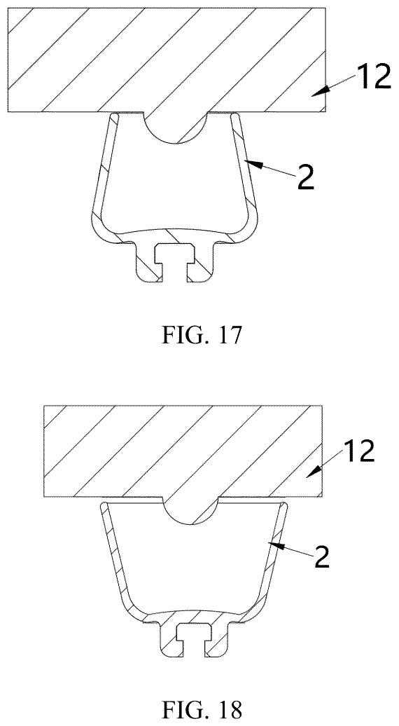

As shown in FIGS. 17-21, in one specific implementation, the variable volume cavity 202 can take on a variety of shapes, for example, a cross-section is funnel-shaped, regular trapezoid, inverted trapezoid, and the like. For example, the massage opening 201 of the variable volume cavity 202 can exhibit a circular, quasi-circular, or two interconnected circular structures.

In one specific embodiment, at least in a first direction, a diameter of the variable volume cavity 202 increases gradually;

as shown in FIG. 13, where the first direction is a direction along the central axis L₀ and directed in a direction of the trajectory unit 3 by the sucking unit 2.

Specifically, the diameter of the variable volume cavity 202 is gradually increased, and since the bottom of the variable volume cavity 202 (a cavity of the variable volume cavity 202 close to the first deformation surface 2021) is caused to deform, a pressure of gas of the variable volume cavity increases when the volume of the variable volume cavity 202 is reduced, and a flow path of the gas flows from the bottom of the variable volume cavity 202 to the massage opening 201; and since the diameter of the massage opening 201 is reduced, a diameter of the bottom of the variable volume cavity 202 is increased, a diameter of the massage opening 201 is reduced when the flow amount of the gas is constant, a pressure of the gas at this position is increased, and the stimulation to the massaged part is increased.

As shown in FIGS. 5-7, an eighth embodiment of the present disclosure provides a sucking massage device, and on the basis of the previous embodiment, the sucking massage device further includes:

a connecting unit 9;

the connecting unit 9 is disposed between the sliding fit main body 401 and the variable volume cavity 202; or

the connecting unit 9 is disposed between the trajectory main body 301 and the variable volume cavity 202.

In this embodiment, the connecting unit 9 is included.

The reason is that this embodiment expects the sliding fit main body 401 or the trajectory main body 301 to form a connection with the variable volume cavity 202, so as to increase a stretching deformation of the variable volume cavity 202 in a stage of forming negative pressure state of the variable volume cavity 202, and ensure that an upper limit of the negative pressure is further increased, and finally, the massage stimulation effects obviously different from that provided by a positive pressure state are produced.

As shown in FIGS. 5-7, in one specific implementation, the connecting unit 9 includes:

a first coupling portion 901 and a second coupling portion 902;

where the first coupling portion 901 is connected to the sliding fit main body 401 or the trajectory main body 301;

where the second coupling portion 902 is connected to the variable volume cavity 202; and

the first coupling portion 901 and the second coupling portion 902 are in clearance fit.

Specifically, the first coupling portion 901 is a spherical structure, the second coupling portion 902 is a spherical groove structure, and the two portions are in sliding fit and clearance fit. When the sliding fit main body 401 or the trajectory main body 301 makes linear movement away from the variable volume cavity 202, the first coupling portion 901 drives the second coupling portion 902 to perform action, such that the variable volume cavity 202 is driven to undergo greater stretching deformation, and greater negative pressure adsorption effects are accordingly produced.

As shown in FIG. 13, a ninth embodiment of the present disclosure provides a sucking massage device, and on the basis of the previous embodiment, the sucking massage device has a handheld end D₁ and a working end D₂;

where the driving unit 5 is assembled to the handheld end D₁; and

the variable volume cavity 202 is assembled to the working end D₂.

In this embodiment, the handheld end D₁ configured to be held by the user, and the working end D₂ is configured to be assembled to the variable volume cavity 202 to produce positive and negative-pressure massage stimulation effects to the part to be massaged 12.

As shown in FIGS. 13-22, a tenth embodiment of the present disclosure provides a sucking massager, including:

the sucking massage device according to any of the above embodiments.

Specifically, the driving unit 5 is connected to an electric control module 11, such as a rechargeable battery.

A specific use process of the sucking massager is as follows: the user holds the massager 10, aligns the massage opening 201 of the variable volume cavity 202 with the part to be massaged 12, and enables the massage opening to be in contact with the part to be massaged. The driving unit 5 is started to rotate the driving end thereof, the sliding fit main body 401 or the trajectory main body 301 is then driven to rotate, such that the trajectory main body 301 or the sliding fit main body 401 makes the linear movement away from or towards the variable volume cavity 202, the variable volume cavity 202 is subjected to compression deformation and stretching deformation, the positive pressure and the negative pressure states of the variable volume cavity 202 are finally formed, and the massage stimulation effects are produced to the part to be massaged 12.

Specifically, the driving unit 5 is the driving motor 501, the sliding fit main body 401 is a barrel-shaped structure, an upper end of the barrel-shaped structure is connected to the bottom (that is, the first deformation surface 2021) of the variable volume cavity 202 through the connecting unit 9, the sliding fit assembly 402 is the positioning pin 4021, and an end of the positioning pin 4021 is slidably connected to the limiting trajectory assembly 302 (the groove 3021 with a trajectory line P₀) of the trajectory main body 301 (a column-shaped structure).

In the description of the embodiments of the present disclosure, it should be understood that the terms “upper”, “lower”, “front”, “back”, “left”, “right”, “vertical”, “horizontal”, “central”, “top”, “bottom”, “top surface”, “bottom”, “inner”, “outer”, “inside”, “outside” and other indicated orientations or positional relationships are based on orientation or position relations shown in the accompanying drawings.

In the description of the embodiments of the present disclosure, it should be noted that, unless otherwise explicitly specified and defined, the terms “mounting”, “connecting”, “connection” and “assembly” should be understood in a broad sense, for example, they may be a fixed connection, a detachable connection, or an integrated connection; and may be a direct connection, or an indirect connection via an intermediate medium, or communication inside two elements. For those of ordinarily skilled in the art, specific meanings of the above terms in the present disclosure could be understood according to specific circumstances.

In the description of the embodiments of the present disclosure, specific feature, structure, material or characteristics described may be combined in a suitable manner in any one or more embodiments or examples.

In the description of the embodiments of the present disclosure, it should be understood that that “-” and “˜” represent the same range of two numerical values, and the range includes end values thereof, for example, “A-B” means a range greater than or equaling to A and less than or equaling to B. “A˜B” means a range greater than or equaling to A and less than or equaling to B.

In the description of the embodiments of the present disclosure, the term “and/or” represents merely an association relationship describing associated objects, indicating that there may be three types of relationships, for example, A and/or B, which means three types of situation, that is, the existence of A alone, the existence of both A and B, and the existence of B alone. In addition, the character “/” herein generally indicates that the associated objects are in an “or” relationship.

Although the embodiments of the present disclosure have been illustrated and described, it should be understood that those of ordinary skill in the art may make various changes, modifications, replacements and variations to the above embodiments without departing from the principle and spirit of the present disclosure, and the scope of the present disclosure is limited by the appended claims and their legal equivalents.

What it claimed is:

1. A sucking massage device having a supporting unit, comprising:
a sucking unit having a massage opening and a variable volume cavity;
a trajectory unit having a trajectory main body and a limiting trajectory assembly;
a sliding fit unit having a sliding fit main body and a sliding fit assembly; and
a driving unit; wherein
the trajectory line P₀ is a 3D trajectory line closed at both ends, the trajectory line P₀ is located in a curved column surface S₀, and a number of intersections Mn wherein a straight line Lₙ intersects with the trajectory line P₀ is 1; and the straight line Lₙ is a straight line arbitrarily passing through a surface of the curved column surface S₀ and parallel to the central axis L₀ of the curved column surface S₀;
the limiting trajectory assembly is connected with the sliding fit assembly to form a first constraint, and the first constraint is used for limiting the sliding fit assembly and the limiting trajectory assembly to maintain a following state on a trajectory line P₀;
the supporting unit is connected with the trajectory unit and the slide fitting unit to form a second constraint, the second constraint is used for enabling the slide fitting unit to have a degree of freedom to make a circular movement relative to the trajectory unit, and an axis of the circular movement is a central axis L₀;
the trajectory main body is connected to the driving unit, and the sliding fit main body is connected to the variable volume cavity; or the trajectory main body is connected to the variable volume cavity, and the sliding fit main body is connected to the driving unit; and
the positive pressure and negative pressure are formed in the variable volume cavity under the control of linear movement of the sliding fit main body or the trajectory main body.

2. The sucking massage structure according to claim 1, wherein
the curved column surface S₀ is a cylindrical curved surface.

3. The sucking massage structure according to claim 2, wherein
the limiting trajectory assembly is a groove connected to or formed on the trajectory main body, the sliding fit assembly is a positioning pin connected to or formed on the sliding fit main body, and the positioning pin is matched and defined in the groove; or
the limiting trajectory assembly is a convex rib connected to or formed on the trajectory main body, the sliding fit assembly is a C-shaped groove snap connected to or formed on the sliding assembly main body, and the C-shaped groove snap is snapped into and limited on the convex rib.

4. The sucking massage structure according to claim 3, wherein
the trajectory main body is a barrel-shaped structure, and the limiting trajectory assembly is connected to or formed on an inner wall of the barrel-shaped structure; or
the trajectory main body is a column-shaped structure, and the limiting trajectory assembly is connected to or formed on an external wall of the column-shaped structure.

5. The sucking massage structure according to claim 2, wherein the trajectory line P₀ further comprises:
an adsorption speed drop section having a starting end J₀ and a terminal end J₁;
an adsorption maintenance section having a starting end W₀ and a terminal end W₁;
a pulse pumping section having a starting end C₀ and a terminal end C₁; wherein
the starting end J₀ is smoothly connected to the terminal end C₁, the terminal end J₁ is smoothly connected to the starting end W₀, and the terminal end W₁ is smoothly connected to the starting end C₀; and
J_{f}>W_{f}, C_{f}>W_{f}, J_{f}, W_{f} and C_{f} are slopes of the sucking speed drop section, the sucking maintenance section, and the pulse pumping section, respectively, and the slope is a ratio of a projection length of a unit trajectory section P₁ of the trajectory line P₀ on the central axis L₀ to a central angle α of the unit trajectory section of the trajectory line on circumference of the curved column surface S₀.

6. The sucking massage structure according to claim 5, wherein
J_{f}>m*W_{f}; and
3≥m≥1.5.

7. The sucking massage structure according to claim 6, wherein
αⱼ≤70°, 100°≤α_{w}≤220°, α_{c}≤70°;
αⱼ, α_{w} and α_{c} are central angles of projection arcs of the J_{f}, W_{f} and C_{f} trajectory sections on the circumference of the curved column surface S₀, respectively.

8. The sucking massage structure according to claim 7, wherein
a first elastic unit, and/or a second elastic unit;
the first elastic unit is disposed on a wall surface of the limiting trajectory assembly away from the variable volume cavity; and
the second elastic unit is disposed on a wall surface of the limiting trajectory assembly near the variable volume cavity.

9. The sucking massage structure according to claim 1, wherein the sucking unit has:
a first deformation surface;
the first deformation surface is a wall surface of the variable volume cavity connected to the sliding fit main body;
the first deformation surface is a wall surface of the variable volume cavity connected to the trajectory main body; and
the first deformation surface is elastically deformable.

10. The sucking massage structure according to claim 1, wherein the sucking unit has:
a second deformation surface;
the second deformation surface is a side wall surface of the variable volume cavity; and
the second deformation surface is elastic.

11. The sucking massage structure according to claim 1, wherein
at least in a first direction, a diameter of the variable volume cavity increases gradually; and
the first direction is a direction along the central axis L₀ and directed in a direction of the trajectory unit by the sucking unit.

12. The sucking massage structure according to claim 1, comprising:
a connecting unit;
the connecting unit is disposed between the sliding fit main body and the variable volume cavity; or
the connecting unit is disposed between the trajectory main body and the variable volume cavity.

13. The sucking massage structure according to claim 12, wherein the connecting unit further comprises:
a first coupling portion and a second coupling portion;
the first coupling portion is connected to the sliding fit main body or the trajectory main body;
the second coupling portion is connected to the variable volume cavity; and
the first coupling portion and the second coupling portion are in clearance fit.

14. The sucking massage structure according to claim 1, wherein
the sucking massage device has a handheld end D₁ and a working end D₂;
the driving unit is assembled to the handheld end D₁; and
the variable volume cavity is assembled to the working end D₂.

15. A sucking massager, comprising:
the sucking massage device according to claim 1.
